(19) United States
(12) Patent Application Publication
(10) Pub. No.: US 2004/0215529 A1
(43) Pub. Date: Oct. 28, 2004

(54) System and method for energy price forecasting automation

(76) Inventors: Andre E. Foster, Smyrna, GA (US); Kevin Greiner, Decatur, GA (US)

Correspondence Address: WOMBLE CARLYLE SANDRIDGE & RICE, P.O. Box 7037, Atlanta, GA, 30357-0037, US

(21) Appl. No.: 10/826,422

(22) Filed: Apr. 16, 2004

(51) Int. Cl. G06F 17/60

(52) U.S. Cl. 705/26; 705/35

(57) ABSTRACT

A method and computer program product for forecasting the retail price of electricity for a customer in a deregulated market and for providing probabilistic valuation of costs and risks. The method includes the steps of performing a digital simulation of marginal clearing prices and hourly customer load to derive expected and probabilistic forecasts of load-weighted wholesale prices and costs for a customer; determining a supplier risk premium to be added to the forecasted retail price based on an expected wholesale price volatility, an expected variability of customer load, and a set of contractual conditions governing price structure, volume flexibility, and financial options embedded within a contract; performing a supply price analysis; and presenting the results of the supply price analysis to the customer. The method can also include the steps of performing a cash flow at risk analysis and/or performing a price duration analysis and/or financial valuation of options embedded in supply contracts such as collars (caps/floors) and contract extension options from the supplier or the end-user and combining the results with the results of the supply price analysis.

### BACKGROUND OF THE INVENTION

The present invention relates generally to computer-implemented forecasting and financial valuation processes and, more particularly, to a system and method for computer-assisted retail-pricing of energy, valuation of contract risk, and presentment of information designed to enhance decision-making for purchasing and managing energy requirements in a deregulated energy market.

Deregulation of the U.S. utility industry is occurring at a rapid rate, with almost every state actively considering deregulation alternatives. Deregulation of the nation's energy utilities will bring about large-scale changes to the energy industry and to the customers that it serves. Retail choice has introduced volatility, uncertainty, and new opportunity for organizations operating in restructured energy markets. In response to this new complexity, energy managers have expressed particular frustration with the lack of price transparency at both the wholesale and retail levels, especially for electricity. Many have conceded that they make energy procurement decisions mostly based on instincts and benchmark information provided by energy consultants (which is typically based on prices received by their other clients in certain markets). Energy managers have stated that possessing reliable forecast information, a better understanding of the components of their energy price, and the capacity to value contractual conditions would assist them in their decision-making and communications to management.

### SUMMARY OF THE INVENTION

The present invention provides supply-side information for large commercial and industrial companies in competitive retail markets. The foundation and differentiating aspect of the information and associated analytics is the retail price forecasting system that provides customer-specific, stochastic forecasts of electricity prices, customer load and electricity supply costs. The raw output data is then synthesized into information that is used by energy managers to optimize energy procurement strategies with respect to such factors as contract lengths, pricing and contractual structures, risk management, and market timing. Additionally, the information can be used to evaluate the expected costs and potential risks of variable pricing structures, capital investment opportunities and operational analysis regarding load shifting and/or demand response/load curtailment programs.

In one aspect, the present invention is directed to a method for forecasting the retail price of electricity for a customer in a deregulated market. The method includes the steps of performing a digital-stochastic simulation of marginal clearing prices and hourly customer load; determining a risk premium to be added to the forecasted retail price based on historical wholesale price volatility, an expected variability of customer load, and the terms and conditions of a supply contract; performing probabilistic supply price and cost analyses; and presenting the results of the supply price analysis to the customer. The method can also include the steps of performing a cash flow at risk analysis and/or performing a price duration analysis and/or financial valuation of options embedded in supply contracts such as collars (caps/floors) and contract extension options from the supplier or the end-user and combining the results with the results of the supply price analysis.

In another aspect, the present invention is directed to a computer program product for forecasting the retail price of electricity for a customer in a deregulated market. The computer program product includes a computer usable medium in which computer readable code is embodied. The computer readable code includes program instructions that determine a risk premium to be added to the forecasted retail price based on expected wholesale price volatility and expected variability of customer load; program instructions that perform supply price analysis; program instructions that perform financial valuation of options embedded in supply contracts such as collars (caps/floors) and contract extension options from the supplier or the end-user; and program instructions that present the results of the supply price analysis to the customer.

The computer program product can also have computer readable code embodied on the computer usable medium containing program instructions that perform a cash flow at risk analysis; program instructions that perform a price duration analysis; and program instructions that combine the result of the cash flow at risk analysis and the price duration analysis with the results of the supply price analysis.

### BRIEF DESCRIPTION OF THE DRAWINGS

The invention is better understood by reading the following detailed description of the invention in conjunction with the accompanying drawings, wherein:

FIGS. 1A-1B illustrate a sample customer load forecast in graphical and tabular form in accordance with an exemplary embodiment of the invention.

FIG. 2 illustrates processing for calculating a deterministic load forecast for customers that factors in seasonal effects, day types, time-of-use patterns and holiday effects.

FIG. 3 illustrates processing logic for estimating short-term stochastic parameters.

FIG. 4 illustrates processing logic for simulating marginal clearing prices and hourly customer load using stochastic modeling of prices and loads.

FIG. 5 illustrates processing logic for the price forecasting automation program in accordance with an exemplary embodiment of the invention.

FIG. 6 illustrates an example of a risk premium curve for associated volume bands based on simulated customer load data.

FIGS. 7A-7B illustrate data formats used for presenting contractual assumptions and a breakout of energy pricing components in accordance with an exemplary embodiment of the invention.

FIG. 8 illustrates an exemplary retail fixed price forecast for a customer including a base case, and an upper and lower percentile forecast over a multi-year planning horizon.

FIG. 9 illustrates a customer-specific energy retail price forecast analysis in a monthly format for a one year time period.

FIG. 10 illustrates a retail supply probability analysis of forecasted energy prices in a histogram format.

FIG. 11 illustrates an exemplary presentation of costs associated with an indexed wholesale power contract in a histogram format.

FIG. 12 illustrates an exemplary graph of a cash-flow at risk analysis for a customer over a calendar year.

FIG. 13 illustrates an exemplary presentation of a price duration analysis for a customer over a calendar year.

FIGS. 14-18 illustrate exemplary interface screens for the price forecasting automation program and methods of the invention.

### DETAILED DESCRIPTION OF THE INVENTION

The following description of the invention is provided as an enabling teaching of the invention and its best, currently known embodiment. Those skilled in the art will recognize that many changes can be made to the embodiments described while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations of the invention are possible and may even be desirable in certain circumstances and are part of the present invention. Thus, the following description is provided as illustrative of the principles of the invention and not in limitation thereof since the scope of the present invention is defined by the claims.

The following definitions of terms used in this description are provided for ease of reference by the reader:

Ancillary Services—those services necessary to support the transmission of energy from resources to loads while maintaining reliable operation of transmission provider's transmission systems.

Cash Flow at Risk (CfaR)—a single measure defined to calculate the expected deviation of a contract's cost (at a specified percentile outcome) from the expected case outcome.

Deterministic Forecast—represents an expected value for a variable such as electricity prices, customer load, or energy costs.

Distribution Loss Factors—a multiple of the electric energy loss in the distribution system. The losses consist of transmission, transformation, and distribution losses between supply sources and delivery points.

End-User—a retail customer of a natural gas or electricity product or services.

Energy Charge—that portion of the charge for electric service based upon the electric energy (kWh) consumed or billed.

Fixed Price Contract—a type of contract where the supply price is fixed over a specific amount of time for a range of volumes, thereby transferring market risk to the supplier.

Forecast of Marginal Clearing Prices (MCP)—a forecast of the hourly or subhourly marginal price of electricity in a given zonal or nodal market.

Holiday Schedules—scheduled times where utility forecasts less consumption based on commercial businesses shutting down.

Independent System Operator (ISO)—a not-for-profit entity established to manage oversee power market operations, including processing of power schedules, forecasting of system load, dispatch of generation resources, procurement of system reliability services, and other wholesale market services.

Indexed Contract—a contract structure where the price follows an indexed measure of market prices. Price and volume risks are transferred to the customer.

Load—the amount of electrical power delivered at any specified point or points on a system.

Load Profile—a representation of the energy usage of a group of customers, showing the demand variation on an hourly or sub-hourly basis.

Load Serving Entity (LSE)—an entity that provides electric service to customers and wholesale customers; load serving entities include retail electric providers, competitive retailers, and non-opt in entities that serve loads.

Monte Carlo Simulation—analytical method that generates random values for uncertain variables to assess risk probabilities through multiple iterations of a mathematical model.

Off-Peak Energy—electrical energy supplied during a period of relatively low system demands as specified by the supplier.

On-Peak Energy—electrical energy supplied during a period of relatively high system demands as specified by the supplier.

Price Duration Analysis—analysis that determines how many times prices fall in defined price bins on an annual basis. Used as a valuation tool to calculate demand-response programs and capital investment opportunities.

Regulated Charges—charges governed by state Public Utility Commission or other entity as adders to basic supply charge (e.g., customer transition charge, transmission and distribution, system benefit).

Stochastic Forecast—A probabilistic forecast developed through Monte Carlo simulation of energy prices and a customer load profile.

Supplier Risk Premium—the cost of shifting market price risk and customer consumption risk to the supplier.

Deterministic Load Forecasting

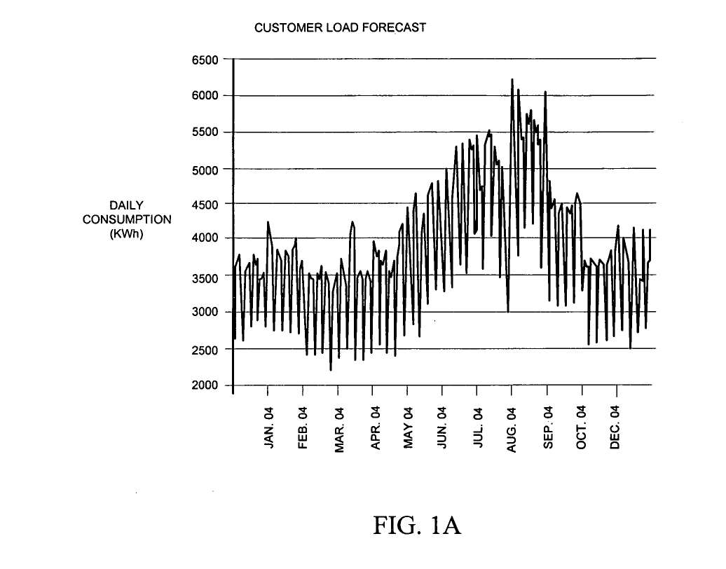

Load forecasting is an essential ingredient in the development of retail supply prices. Utility grade load forecasting software is first used to develop a deterministic zonal forecast for a customer's facilities. For weather dependent loads, the load forecasting software “weather normalizes” the profile for increased accuracy. Once a forward view of consumption is created, the expected load is modeled stochastically to generate a probabilistic view of how customer load will vary throughout the year. The resulting forecast allows the clients to understand the variability in their load consumption and creates the opportunity to develop suitable volume bands for supply contracts. With this information, the present invention can evaluate energy spending for various pricing structures and assist clients in mitigating volume risk by ensuring that a contract has a sufficient level of volume flexibility. FIGS. 1A-1B illustrate the manner in which the customer load forecast data is presented to the client in graphical and tabular form, respectively.

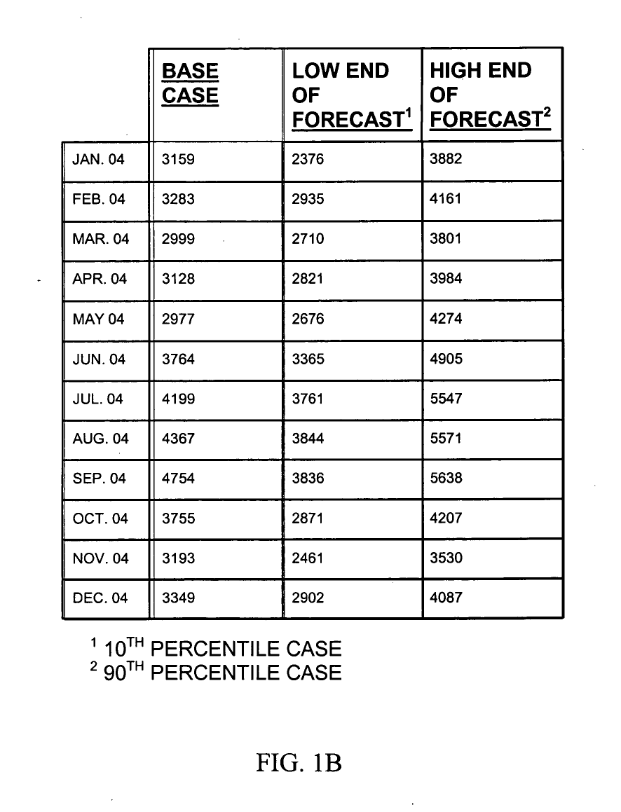

FIG. 2 illustrates the methodology for calculating a deterministic load forecast for customers. The method starts with collection of customer load data as indicated in block 200. Customer load data is imported into an application, such as the RACM application available from Henwood Energy Services, that forecasts load consumption based on historical demand curve, peak demand, and weather factors. This step is indicated in block 202. A test is then performed in decision block 204 to determine if the historical customer load data is in the form of monthly or interval kWh measures. If the data is in interval form, the “yes” path is followed. The customer load profile is analyzed in block 206. The customer load data is grouped to reflect observed patterns as indicated in logic block 208. Next, a test is made in decision block 212 to determine if the data is weather dependent. If the data is weather dependent, then the customer load profile is normalized for weather effects as indicated in logic block 214. Regardless of the interval data being weather dependent or not, the next step in the process is to perform a regression methodology using ordinary least squares, as indicated in logic block 216. The output from the regression analysis is a deterministic load forecast on an hourly basis as indicated in logic block 230. If in decision block 204, the data is not in interval form, the “no” path is followed. A standard load profile for the customer data is imported from the distribution company for the customer's rate class as indicated in logic block 210. The customer load profile is analyzed in block 218. The customer load data is grouped to reflect observed patterns as indicated in logic block 220. A test is made in decision block 222 for weather dependency. If weather dependent, the load profile is normalized for weather effects in logic block 224. Following normalization of the load profile for weather effects, a comparative period methodology is applied to the load profile in logic block 226. The output from the comparative period methodology is the deterministic load forecast on an hourly basis as indicated in logic block 230. If the load data is not weather dependent, then a scale factor methodology is applied to the load profile in logic block 228 to arrive at a deterministic load forecast in logic block 230. The following paragraphs provide further clarification on the logic blocks depicted in FIG. 2.

After collecting load data from the client (block 200) and importing the data into the load forecasting application (block 202), the data is graphed to view: (1) seasonal effects, (2) day-types, (3) time-of-use patterns, and (4) holiday effects. Each of these represent characteristics specific to the end-customer. For example, the typical profile of a commercial retailer would have a seasonal load pattern of peak consumption in the summer (due to air conditioning loads) and lowest usage during the spring and autumn. The store hours may run from 8 AM-8 PM and not require much energy usage after closing. Each of these characteristics needs to be accounted for in the forecast for a more accurate picture of where the consumption could trend in the future. The analysis of load profile and grouping of the load to reflect observed patterns are represented by blocks 206, 208 on the “yes” path and by blocks 218, 220 on the “no” path out of decision block 204.

Understanding end-user consumption patterns is important to determining what type of load forecasting model to use. The three factors that have the most influence on consumption are econometric measures, weather, and operational measures. Examples of econometric measures are population, employment, income and gross national product (GNP). Examples of operational measures are production scheduling for industrial end users and store hours for commercial end users. For some customers, weather greatly influences load consumption by shifting the demand curve up or down by a percentage change in temperature. Therefore, for weather dependent loads, the load profile is normalized by making adjustments for historical weather patterns (blocks 214, 224). Non-weather dependent loads (e.g., industrial factors) are not adjusted for weather effects, but can be normalized based on inputs from the customer about production scheduling and other variables.

One of three different methodologies is used in developing the deterministic load forecast (block 230). These include scale factor methodology (block 228), comparative period methodology (block 226), and regression methodology (block 216). In scale factor methodology (block 228), scale factors reflect the percentage difference of a particular customer's consumption from the generalized load shape for that customer's class. Scale factors are calculated and used for forecasting in a commercially available application that forecasts load consumption (e.g., Henwood RACM). Comparative period methodology (block 226) includes temperature adjustments and seasonally specific elasticities for load responses to heating and cooling degree-days, and calendar adjustments. Regression-based forecasting (block 216) is used to develop independent forecasting equations that reflect weather, processes or other statistically relevant variables.

Stochastic Modeling of Market Energy Prices and Load

The stochastic modeling process involves allowing forecasts to deviate from deterministic values according to a set of statistical parameters. The effect is to simulate variability and uncertainty that inherently exists in complex power markets and customer load profiles, and to yield probabilistic forecast analyses that reflect a range of expected outcomes. A risk simulation model, such as the RiskSym application available from Henwood Energy Services, can be used to perform the calculations needed to create Monte Carlo simulation results for probabilistic analyses of hourly energy prices and load consumption.

The general model used by the RiskSym application is a two-factor lognormal mean-reverting stochastic model. One factor represents short-term deviation around an average or equilibrium level. The second factor represents long-term uncertainty of the equilibrium and captures random walk. The present invention provides a defined process for developing short-term stochastic parameters as described below. The long-term parameter reflects general market knowledge from the industry and such knowledge is provided by Henwood Energy Services or other energy information sources.

The term mean-reversion implies that a variable (whether price or load) oscillates around an equilibrium level. Every time the stochastic term gives the variable a push away from the equilibrium, the deterministic term will act in such a way that the variable will start heading back to the equilibrium. Historically, energy prices have exhibited this type of mean-reversion behavior.

Key features of the model include:

a lognormal electricity price and load distribution is assumed;

an allowance of seasonal varying volatility and correlation parameters to handle cyclical price and consumption patterns of energy commodities.

The simulation model is run for a simulated time period up to 20 years. This involves hourly Monte Carlo random draws for electricity prices and load consumption and may be performed for 100 or more iterations over the simulation time frame.

Short-Term Stochastic Parameter Estimation

In order to run the stochastic model in the risk simulation application, a set of short-term stochastic parameters must be calculated. To that effect, the present invention derives volatility of and correlations between price and customer load on a seasonal basis to effectively capture future trends and weather effects.

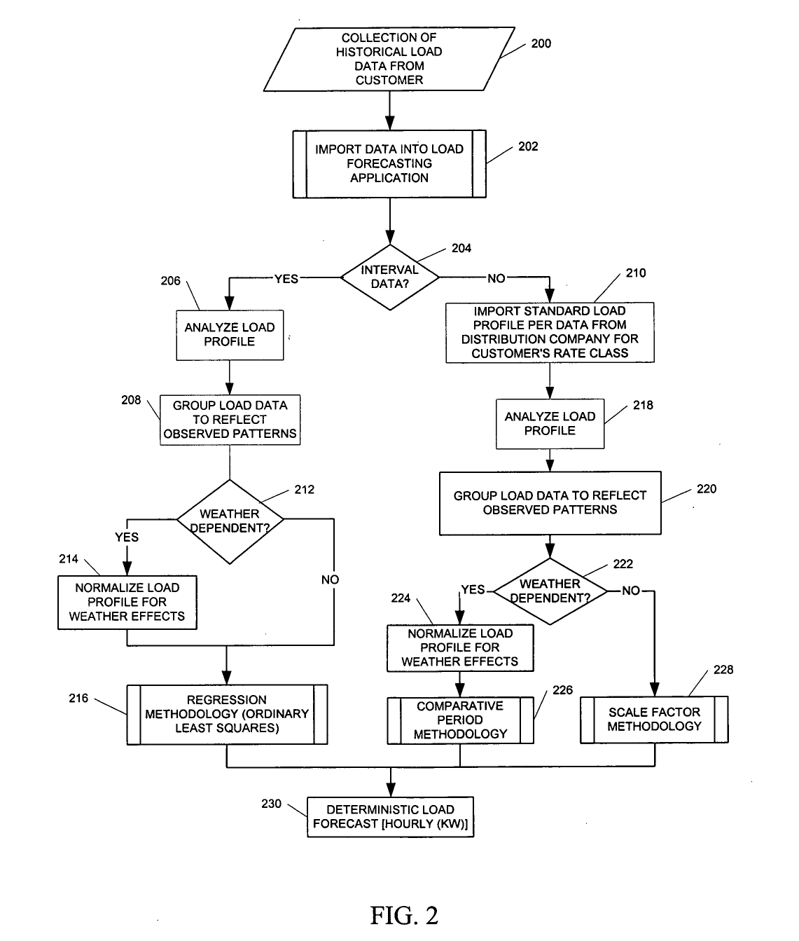

FIG. 3 illustrates processing logic for estimating short term stochastic parameters. Processing starts in block 300 with collection of historical energy consumption data from the customer. A test is made in decision block 302 to determine if the data is in interval format. If it is, the “yes” path is followed and historical energy price data is located to match with the historical load profile as indicated in block 304. Weekend data is then removed to dampen the volatility of the price and load profile as indicated in logic block 310. If the historical consumption data is not in interval format, the “no” path is followed and an hourly standard load profile is created according to the customer rate class as indicated in logic block 306. Historical energy price data is then located to match historical load profile data as indicated in logic block 308. This is followed by removal of weekend data to dampen volatility of price and load profile as indicated in logic block 310. Next, the data is imported into a statistical analysis application such as the RiskSym available from Henwood Energy Services as indicated in logic block 312. Next, in decision block 314, a test is made to determine the type of data set that has been imported into the statistical analysis application. For historical energy market price data, an estimation model is selected as indicated in logic block 316. For historical customer load profile data, the estimation model is selected in logic block 318. From either logic block 316 or 318, processing continues with derivation of the stochastic parameters for the selected estimation model as indicated in logic block 320. This is followed in logic block 322 with determination of seasonal parameters for stochastic modeling of price and load. Various logic blocks are described in greater detail in the following paragraphs.

Essentially, there is a four-step process to establish short-term stochastic parameters.

Step 1: Collect Historical Load Data and Generate an Hourly Historical Load Profile (block 300)

To the extent that customer data is in monthly (kWh) format, the data has to be transformed to an hourly format by matching the customer load profile with the utility's standard load profile of that customer's class (block 306). This process involves calculating the ratio between the monthly consumption of standard load profile and customer's actual consumption. The process then multiplies each interval by the ratio to approximate hourly consumption (KW format). If the data is in interval (KW) format (decision block 302), no such conversion is necessary.

Step 2: Pull Historical Hourly Price Data from Publicly Available Sources that Matches Timeframe of Load Data (blocks 304, 308, 310)

In order to effectively correlate price and load, the estimation process uses actual market prices that occurred during the same time period as the load data. These data sets are then used to develop seasonal correlations between prices and loads. For weather dependent loads, this is particularly important since higher consumption will typically occur during periods with high prices. If historical electricity price data is not available, other available information such as fuel prices is combined with knowledge of the supply curve and generation fuel mix to derive a compatible price index that can be correlated with customer load. For example, in markets where natural gas tends to be the fuel for price-setting plants, natural gas prices may be used as the index with which the stochastic parameters are derived.

Step 3: Import Both Data Sets Into a Statistical Analysis Application that Performs a Linear Regression and Other Statistical Analytics (block 312)

Step 4: Select Appropriate Estimation Model (Blocks 316, 318)

Using a defined process, select the estimation model that will most accurately reflect historical behavior of both load and energy prices. The stochastic estimation model selected is the one that most accurately reflects historical behavior of a customer's load and energy prices. This step involves the following processes:

(a) Review Historical Price and Load Data

The historical price and load data are graphed to view trends by season and to capture periods of high volatility and/or price events.

(b) Select Statistical Model (blocks 316, 318, 320)

The resulting shape of the distribution of values is then used to determine an appropriate statistical model for stochastic modeling. It is widely accepted in the industry that energy commodity prices do not fit into normal distribution models. Most customer loads also are not normally distributed. Lognormal distributions are generally a better representation for both price and load, except for extreme events in which spikes or jumps occur. In that case, Markov Regime Switching (MRS) models are more appropriate. The advantage that an MRS model has over a lognormal model is its ability to simulate a price distribution that includes infrequent but large upward price spikes by estimating distinct mean and volatility parameters for both a low price state and a high price state. Thus, the lognormal and MRS models are most commonly utilized.

(c) Test Results

Once a model has been selected, it is tested against other estimation models and stressed (e.g., determine impact of a shift change or gas spike) to ensure correct correlative values, volatility, and mean-reversion.

The statistical analysis linear regression model calculates (block 322) the following short-term stochastic parameters: (a) seasonal short-run mean-reversion and volatility parameters; and (b) correlations between the seasonal regression residuals of historical load and historical prices. In other words, a set of statistical values are developed representing: (1) a seasonally-based standard deviation and mean-reversion of historical market prices and customer load, and (2) a seasonally-based correlation between the historical market prices and customer load.

Monte Carlo Simulation Process

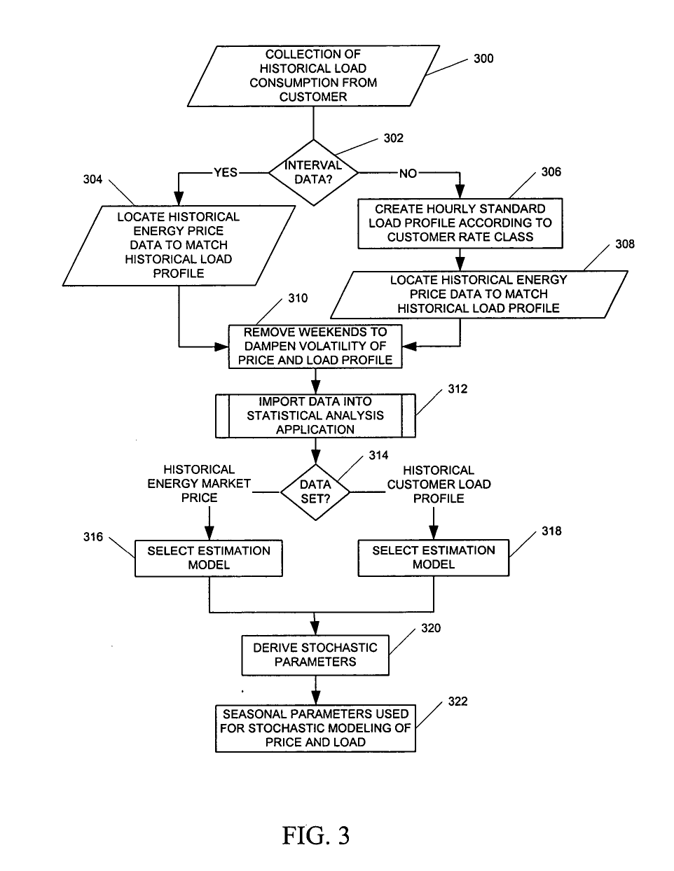

The deterministic load forecast on an hourly basis that is produced from the processing logic of FIG. 2 (logic block 230) and shown at block 402 in FIG. 4 is one of the inputs into a stochastic simulation application (block 408) that performs Monte Carlo simulations of marginal clearing prices and hourly customer load. A second input into the stochastic simulation application is a deterministic forecast of market clearing prices per zonal hub per market, as indicated in block 404. The seasonal parameters used for stochastic modeling of price and load that is output in logic block 322 of FIG. 3 and represented in logic block 406 is an additional input into the stochastic simulation application. Operation of the stochastic simulation application then results in Monte Carlo simulation results of marginal clearing prices as indicated in block 410 and hourly customer load as indicated in block 420. Further details on the processing logic of FIG. 4 is described in the following paragraphs.

As shown in FIG. 4, a deterministic forecast of market energy prices (block 404) and a deterministic forecast of the customers' consumption (block 402) (as described in the Deterministic Load Forecasting section) are inputs into the stochastic simulation application (block 408). The market energy price forecast (block 404) comes from a fundamental analysis performed by looking at variables such as power plant costs, fuel prices, maintenance schedules, demand forecasts and transmission constraints. These variables are stochastically modeled to create an expected view of prices in specific markets.

Output from the stochastic simulation application yields stochastically modeled hourly load (block 420) and wholesale price (block 410) data for the number of iterations performed. Exemplary outputs are shown in Tables 1 and 2, below. Table 1 shows the simulated energy prices on an hourly basis over a calendar year, with “i” iterations being performed to simulate each hour's energy price forecast. Table 2 shows the simulated load forecast on an hourly basis over a calendar year with “i” iterations being performed to simulate each hour's load forecast.

TABLE 1
Monte-Carlo Simulated Energy Price Forecast ($/MWh)

| | | **Time | | Iteration | |
|---|---|---|---|---|---|
| Year | Date | Interval j | Iteration 1 | 2 . . . | *Iteration i |
| 2004 | Jan. 1, 2004 | 1 | 20.23 | 22.69 | 18.36 |
| 2004 | Jan. 1, 2004 | 2 | 20.45 | 23.14 | 19.01 |
| 2004 | Jan. 1, 2004 | . | 20.64 | 23.42 | 19.81 |
| | | . | | | |
| | | . | | | |
| 2004 | Jan. 1, 2004 | 24 | 35.15 | 32.25 | 38.62 |
| . | . | . | . | . | . |
| . | . | . | . | . | . |
| . | . | . | . | . | . |
| 2004 | Dec. 31, 2004 | 24 | 38.22 | 36.68 | 37.69 |

TABLE 2
Monte-Carlo Simulated Load Forecast (KW)

| | | **Time | | | |
|---|---|---|---|---|---|
| Year | Date | Interval j | Iteration 1 | Iteration 2 | *Iteration i |
| 2004 | Jan. 1, 2004 | 1 | 1021.20 | 1108.25 | 1365.68 |
| 2004 | Jan. 1, 2004 | 2 | 1532.21 | 1000.65 | 1236.45 |
| 2004 | Jan. 1, 2004 | . | 1601.83 | 1263.75 | 1250.34 |
| | | . | | | |
| | | . | | | |
| 2004 | Jan. 1, 2004 | 24 | 1109.36 | 1230.05 | 1298.62 |
| . | . | . | . | . | . |
| . | . | . | . | . | . |
| . | . | . | . | . | . |
| 2004 | Dec. 31, 2004 | 24 | 1025.69 | 1311.58 | 1241.21 |

*i = iteration
**j = time interval (e.g., 15 min. or hourly)

Price Forecasting Automation Application

The Monte Carlo simulated energy and load forecast datasets are moved into the Price Forecasting Automation application, which performs calculations for the retail supply price, risk premium cash flow at risk (CFaR), price duration and other forecast risk analytics.

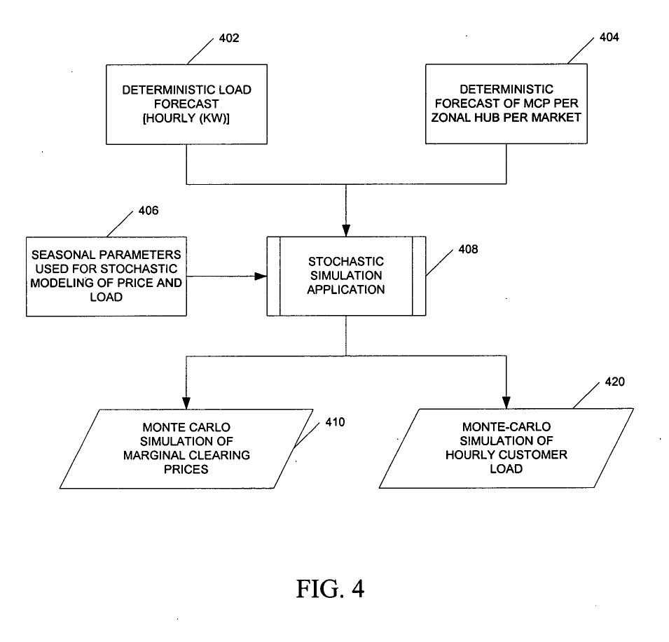

FIG. 5 illustrates processing logic for the Price Forecasting Automation Program (block 500), that takes these simulation results (block 512, 514) and performs calculations for the retail supply price (block 550), risk premium (block 548), CfaR (block 522), and price duration analytics (block 554).

In more detail, the Monte Carlo simulation results of marginal clearing prices from block 410 and hourly customer load from block 420 of FIG. 4 are represented in FIG. 5 by blocks 512 and 514, respectively. The simulation of marginal clearing prices and hourly customer load are input into the price forecasting automation program as indicated in logic block 516. From the program main menu of logic block 516, processing continues in one of several additional logic blocks. The risk analysis portion of the processing logic begins in logic block 525 following determination of the load-weighted wholesale price in block 518. One of the option types (decision block 530) on which the risk analysis can be performed is by volumetric demand (block 540). Another option type for risk analysis is the price risk option (block 532). For volumetric demand risk analysis, processing continues in decision block 540 with a determination of the type of contract that is associated with this particular customer's risk analysis. The different volumetric demand options are fixed price contract, represented by logic block 542; time of use contract, represented by logic block 544, and indexed contract represented by logic block 546. A risk premium calculation is then performed by the price forecasting automation program as indicated in logic block 548. Following the risk premium calculation, supply price analysis is performed as indicated in logic block 550. One of the inputs that goes into the supply price analysis are retail administration charges as indicated in logic block 524. Cash flow at risk analysis represented by logic block 552 and/or price duration analysis, as represented in logic block 554, can then be performed along parallel paths. The results of these analyses are entered in to an output spreadsheet as indicated in logic block 508. From the output spreadsheet 508, presentation of the data can be made to the customer as described further herein. This processing step is indicated in logic block 520. Corresponding analytical output from the data presentation logic block 520 is represented in block 528. Another feature of the price forecasting automation program is database management performed as represented by logic block 522. Distribution loss factors are one of the outputs that can be derived from analysis of data stored in the database as indicated in block 526. More detailed discussion of the various processing blocks of FIG. 5 are described in the following paragraphs.

The final retail price calculation is the summation of several components including: (1) load-weighted wholesale price; (2) line loss adder; (3) system reliability charges; (4) supplier risk premium; and (5) overhead and margin.

This list of components represents the analyses that must be performed and/or located through publicly available information, to develop a final price of electricity to customers. Final supply prices for forecasts greater than one year are adjusted for inflation using economic inflation rates.

1. Load—Weighted Wholesale Price Calculation (C) (block 518)—the load-weighted wholesale price is calculated as a weighed average cost per MWh to supply the customer with power before any administration charges, risk premiums, and system reliability charges are added. Typically, C can represent over 60% of the total supply price given to a customer and is dependent on variables such as the expected load profile, forecasted market prices, and contract period. Using the Monte Carlo simulated results for price and load, the invention calculates two forms of C for use in various analyses:

Iterated Load-Weighted Wholesale Price (Cᵢ)—The following equation yields “n” discrete iterations of C over a specific time parameter “k” used for probabilistic analysis of supply contracts.

For i=to i=n

$${C}_{i} = \frac{{\sum }_{j = 1}^{j = k} ( {AP}_{i , j} \times {AL}_{i , j} )}{{\sum }_{j = 1}^{j = k} {AL}_{i , j}}$$

Next i

where

Cᵢ=load—weighted wholesale price for iteration i ($/MWh)

AP_{i,j}=simulated energy market clearing price for time interval j and iteration i ($/MWh)

AL_{i,j}=simulated customer load for time interval j and iteration i (MWh)

j=time interval j=1,2,3, . . . k

i=iteration i=1,2,3, . . . n

Expected Load-Weighted Wholesale Price (Cₖ)—The following equations yield an expected Cₖ based on “n” different iteration of load and price data for a period lasting “k” intervals. This calculation is used for risk premium analysis and option valuation.

$${C}_{k} = \frac{{\sum }_{i = 1}^{i = n} {C}_{i}}{n}$$

where

Cᵢ=load—weighted wholesale price for iteration i ($/MWh)

Cₖ=expected load—weighted wholesale price for a series of iterations i ($/MWh)

j=time interval j=1,2,3, . . . k

i=iteration i=1,2,3, . . . n

2. Line Loss Adder—line losses represent the amount of power lost over transmission and distribution lines. In most markets, distribution companies stipulate line loss factors for each rate class of customer. Because line losses decrease with increased voltage, customers who receive power at transmission level voltages are typically charged ˜3%. For secondary distribution, this charge can reach ˜10%. The following equation represents the actual adder to the supply price for a customer:

For i=1 to i=n

LL1=Cj x Line Loss Factor

Next i

where

LLᵢ=line loss factors—public information provided by the distribution company

Cᵢ=load—weighted wholesale price for iteration i ($/MWh)

3. System Reliability Charges (Other Charges)—system reliability represents the ability of the electric system to supply the aggregate electrical demand and energy requirements of its customers at all times, taking into account scheduled and reasonably expected unscheduled outages of system elements. Additionally, it entails taking proper steps to withstand sudden disturbances such as electric short circuits or unanticipated loss of system elements. These charges are borne by load serving entities and passed on to their customers.

There are two main types of system reliability charges that are forecasted and valued: installed capacity (ICAP) and ancillary service charges. ICAP is a product that Load Serving Entities (LSE's) are required to purchase to meet their customers' capacity requirements plus a stipulated reserve margin. Typically, the Independent System Operator (ISO) sets a reserve margin and then allows the market to set the ICAP prices. Ancillary services represent real-time services procured from generators to ensure system balance and power quality. Ancillary service charges can include spinning reserves, non-spinning reserves, replacement reserves, regulation-up, regulation-down, and black start. The ISO purchases these services through one or more market mechanisms and passes these costs to LSE's based on their contracted loads. The invention forecasts these system reliability charges using the following equation:

FSR=Forecasted price of system reliability charges*[Average quantity of system services procured]/[Total MWh consumed in the market]

where

FSR=Forecast of System Reliability Charges applicable to customer ($/MWh)

4. Supplier Risk Premium (RPₖ)—as described below, the supplier risk premium is a function of price structure (fixed, time of use, or indexed contract), contract length, price volatility, load variability, and degree of contractual volume flexibility. With this information, the invention uses valuation techniques to develop the risk premium adder for the supplier retail price.

5. Overheads and Margin (O&M)—an ongoing database has been developed to monitor and record the additional uplift in retail prices. This uplift represents such cost elements as credit; selling, general and administrative (SG&A) expenses; and infrastructure. These are assessed by market by taking a short-term retail price (either a supplier offer or default price) and solving for the overhead and margins algebraically:

Overhead+Margin=Short Term Retail Price-(Load-Weighted Wholesale Price+Line Losses+System Reliability Charges+Supplier Risk Premium)

The following equations represent the summation of each component to yield a fixed price retail supply forecast.

For i=1 to i=n

FPᵢ=Cᵢ+LLᵢ+FSR+RPₖ+O&M

Next i

$${FP}_{k} = \frac{{\sum }_{i = 1}^{i = n} {FP}_{i}}{n}$$

where

FPᵢ=fixed price retail supply forecast for iteration i ($/MWh)

FPₖ=expected fixed price retail supply forecast ($/MWh)

Cᵢ=load-weighted wholesale price for iteration i ($/MWh)

LLᵢ=line loss factors—public information provided by the distrubtion company ($/MWh)

FSR=forecast of system reliability charges applicable to customer ($/MWh)

RPₖ=total risk premium over specified time interval k ($/MWh)

O & M=overhead and margin ($/MWh)

Retail Risk Premium Calculation (Block 548)

Retail electricity suppliers generally manage some price and volume risks on behalf of customers. Electricity market prices and customer consumption are inherently variable, and offering a fixed price for a variable consumption volume entails managing these risks. As compensation for taking these risks, suppliers must properly calculate a risk premium that they will charge the customer. To the extent that the customer is willing to hold some of these risks itself, the supplier risk premium can be expected to be correspondingly lower.

The present invention provides a detailed methodology for quantifying the costs of a risk premium for a specific customer load. A methodology is also provided for determining how these risks should be properly allocated financially between the supplier and a customer based on contractual structures.

The retail risk premium is a function of two factors: expected wholesale price volatility and expected variability of the customer load (load forecasts). Wholesale price volatility is derived by stochastically modeling market prices (block 512). A deterministic hourly or subhourly forecast view of wholesale market prices (MCP's) is an input to the stochastic simulation application as discussed above. There is a positive correlation between expected price volatility and the risk premium.

A deterministic load forecast is developed using a load forecasting model. Raw data comes in the form of monthly or interval kWh measures. This profile is adjusted based on weather dependency and/or material changes in the customer load profile. The load forecast is then stochastically modeled (block 514) to capture variability and establish volume bands for the customer. There is a positive correlation between expected load variability and the risk premium.

The risk premium for a fixed-price contract is derived using the Monte Carlo results from the stochastic modeling of prices and load. The inventive method uses a three-step process for deriving the supplier risk premium.

Step 1: Capture the Expected Load-Weighted Wholesale Price (Cₖ)

The resulting value represents the weighted-average wholesale price of power for serving a specific load, based on iterative forecast output of interval prices and load as derived in block 518.

Step 2: Calculate the Total Risk Premium Associated with Serving a Customer Load (Block 548)

Since the load-weighted wholesale price is based on an expected customer load, to the extent that the actual customer load deviates from expected values, the supplier will need to purchase or sell back power volumes. For example, if the customer's demand is greater than expected for a time interval, the supplier will purchase incremental volumes at the then prevailing spot or forward market price to meet these load requirements. Conversely, if the customer's demand is less than expected, the supplier will receive a prevailing spot or forward market price for the volumes that are not consumed by the customer. This volume swing (or demand option) leads to a risk premium that must be valued to properly derive a retail price forecast. The total risk premium associated with serving a customer load is determined as follows:

a) The retail risk premium associated with serving a customer load for a specific interval period is:

For j=1 to j=k

If Cₖ>AP_{i,j}

$${RP}_{j} = \frac{{\sum }_{i = 1}^{i = n} [ ( {AP}_{i , j} - {C}_{k} ) \times ( {EL}_{j} - {AL}_{i , j} ) ]}{n}$$

If Cₖ<AP_{i,j}

$${RP}_{j} = \frac{{\sum }_{i = 1}^{i = n} [ ( {C}_{k} - {AP}_{i , j} ) \times ( {AL}_{i , j} - {EL}_{j} ) ]}{n}$$

Next j

where

RPⱼ=expected incremental costs (gains) to serve a load during time interval j ($)

ELⱼ=determinsitic forecast of load for time interval j (MWh)

Cₖ=load-weighted wholesale price for specified time interval j ($/MWh)

AP_{i,j}=simulated energy market clearing price for time interval j iteration i ($/MWh)

AL_{i,j}=simulated customer load for time interval j iteration i (MWh)

j=time interval j=1,2,3, . . . . k

i=iteration i=1,2,3, . . . n

b) The total risk premium associated with serving a customer load for a set of iterations is the weighted average of the risk premium calculated for each time interval:

$${EL}_{k} = {\sum }_{j = 1}^{j = k} {EL}_{j}$$

$${RP}_{k} = \frac{{\sum }_{j = 1}^{j = k} {RP}_{j}}{{EL}_{k}}$$

where

RPₖ=total risk premium over specified time interval k ($/MWh)

ELⱼ=deterministic forecast of load for time interval j (MWh)

ELₖ=sum of deterministic forecasts through time interval k (MWh)

AL_{i,j}=simulated load for iteration i and time interval j (MWh)

The risk premium calculation can be interpreted as the expected losses (or gains) associated with providing a customer with volume flexibility at a fixed price. Since most customer loads are somewhat weather-dependent, loads and prices typically exhibit some degree of correlation. If the supplier grants the customer contractual volume flexibility, this has the effect of leading to financial losses for the supplier for those volumes that must be incrementally bought or sold due to a customer's deviation from an expected load profile. Table 3 provides an example of risk premium computation from Monte-Carlo simulated energy price and customer load forecast ($/MWh) for one sample iteration.

TABLE 3

| | | | Cₖ | AP_{i,j} | | | |
|---|---|---|---|---|---|---|---|
| | | | ($/ | ($/ | EL_{i,j} | AL_{i,j} | |
| Year | Date | Hour | MWh) | MWh) | (MW) | (MW) | RPⱼ* |
| 2004 | Jan. 1, 2004 | 1 | 40 | 42 | 20 | 20 | 0 |
| 2004 | Jan. 1, 2004 | 2 | 40 | 43 | 21 | 22 | (3) |
| 2004 | Jan. 1, 2004 | . | | | | | |
| | | . | | | | | |
| | | . | | | | | |
| 2004 | Jan. 1, 2004 | 24 | 40 | 37 | 19 | 18 | (3) |
| . | . | . | | | | | |
| . | . | . | | | | | |
| . | . | . | | | | | |
| 2004 | Dec, 31, | 24 | 40 | 48 | 16 | 20 | (32) |
| | 2004 | | | | | | |
| *RPⱼ represents gains (losses) associated with purchasing or selling back power volumes that deviate from the expected load, ELⱼ. | | | | | | | |
| # If Cₖ > AP_{i,j}, it is (AP_{i,j} − Cₖ) × (ELⱼ − AL_{i,j}). | | | | | | | |
| # If Cₖ < AL_{i,j}, it is (Cₖ − APᵢⱼ) × (AL_{i,j} − ELⱼ). | | | | | | | |

Allocation of the Retail Risk Premium Between Supplier and Customer

The invention provides a process for quantifying the proportion of the retail risk premium that is borne by the supplier and by the customer. This is an important analysis, because customers often do not have transparency into what they are being charged for management of price and volume risk by their supplier, nor how much risk they are implicitly assuming in their contracts. A financial valuation of the risk premium is used in the present invention to identify inefficiencies in how it may be priced by suppliers. Such an analysis can lead to opportunities for customers to reduce their costs at small incremental risk, or to reduce risk at small incremental cost.

The financial allocation of a retail risk premium between a supplier and a customer is a function of the contractual terms governing price and volume flexibility.

1. Contractual Terms Governing Price

There are three basic pricing structures for electricity in deregulated markets: fixed price, time-of-use (TOU), and variable/indexed. Fixed price contracts (block 542) are among the most common pricing structures because they are easy to understand and provide a higher degree of budgetary certainty for expense allocation. These involve fixing retail supply prices for a quantifiable time period and consumption range, thus transferring energy price and volume risk to the supplier. For taking on these risks, suppliers add a premium to cover a) their costs of hedging price risk associated with expected volumes, and b) the expected cost of the volume swing (demand option) held by the customer.

TOU contracts (block 544) are instruments that divide fixed supply prices into two or more time blocks (on-peak, shoulder, and off-peak). Although supplier risk associated with this contract structure is lower, valuation of the premium can be conducted using similar methodologies to the fixed price risk premium adder. Specifically prices and loads are grouped into the time-of-use periods to calculate risk premiums separately for each time-of-use period.

Indexed/variable contracts (block 546) transfer energy and volume risks to the end-user. There is typically little, if any, risk premium associated with these contracts for the supplier.

2. Contractual Terms Governing Demand-Based Volume Swing (Block 540)

Volume bands are a type of demand option where customers request a specific “swing” from an expected (baseline) consumption pattern. The swing may provide the customer with the flexibility to consume more or less electricity than the assumed baseline (usually represented as a +/− percentage of historical monthly consumption or some other benchmark measure). As a result, premium valuation is highly correlated with the amount of swing requested in a contract. The higher the allowable volume swing, the higher the risk exposure for the supplier that prices will be above the expected consumption levels. This should lead to a correspondingly higher risk premium embedded in a contract price.

The present invention uses a two-step process to quantify the economically-based allocation of the retail risk premium between supplier and customer.

Step 1: Review Stochastic Load Forecast to Determine Iterations Where Customer's Load was Outside Allowable Volume Bands

For iterations where the customer's consumption was between a minimum and maximum volume, all incremental costs associated with providing less or more volume than expected values are the responsibility of the supplier.

To the extent that consumption is outside of pre-determined volume bands, the supplier will only be financially responsible for variances within the volume band, and the customer will be financially responsible for all variances outside of these bands.

Step 2: Calculate Supplier and Customer Allocation of the Total Retail Risk Premium

For those iterations where the customer's consumption is calculated to be outside of volume band limits, the invention calculates the financial settlement that would be required.

For example, the customer may have the right to consume +/−10% of historical monthly volumes without penalty. If the customer is outside of these bounds in any given month, the supplier passes through the net costs of supplying or selling back the incremental volumes using a formula that is linked to market prices.

Step 3: Illustrate the Cost and Risk Trade-Offs of Different Contractual Structures Governing Price and Volume Flexibility

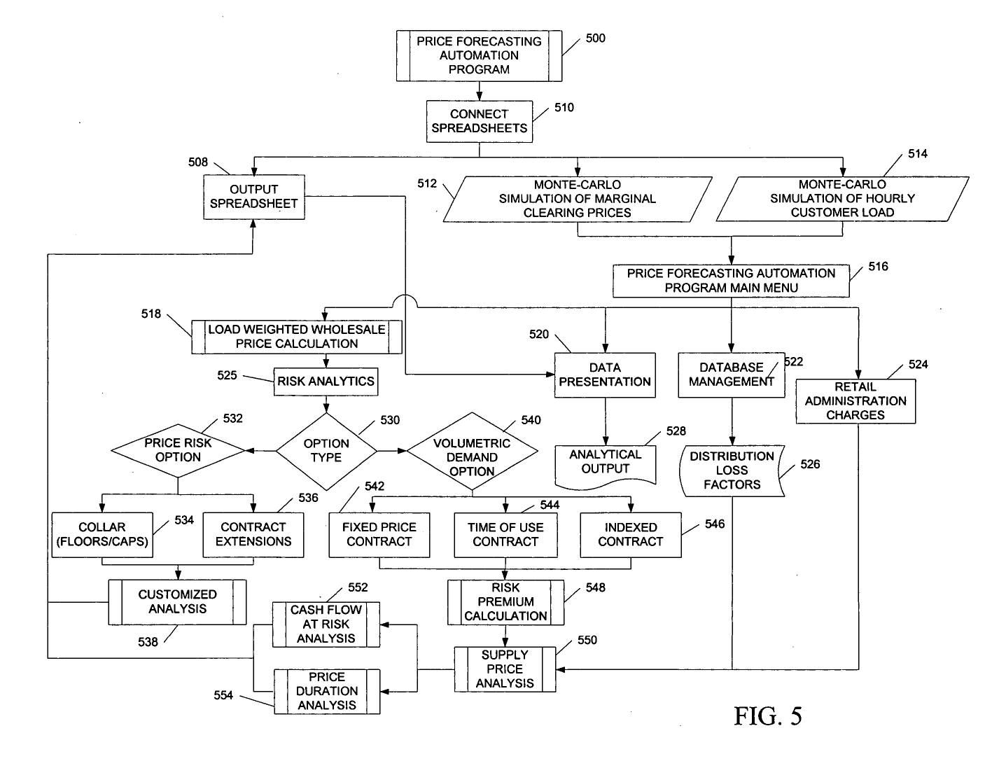

Depending on the customer's appetite for risk, the supplier risk premium may be reduced by decreasing volume flexibility. Conversely, the customer may also be interested in increasing volume flexibility and paying a somewhat higher fixed price in return. FIG. 6 depicts such an analysis, which provides the customer with a valuation of the supplier risk premium at varying volume bands. In this example, the analysis predicts that a customer should be able to reduce its supply price by approximately $1/MWh by reducing the volume band from 10% to 4%.

The benefits of such a strategy is then evaluated against the additional risks, as there would be a greater probability that the customer will be outside of it volume bands and therefore be exposed to market prices for a portion of its load requirements.

A customer can use this information to negotiate a reduced price with the supplier, or to identify opportunities where the risk premium is not being properly priced by the supplier.

Presentation of Fixed-Price Forecast Results

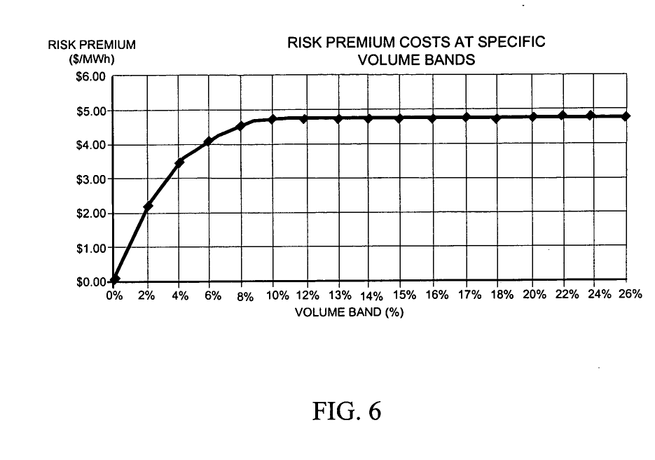

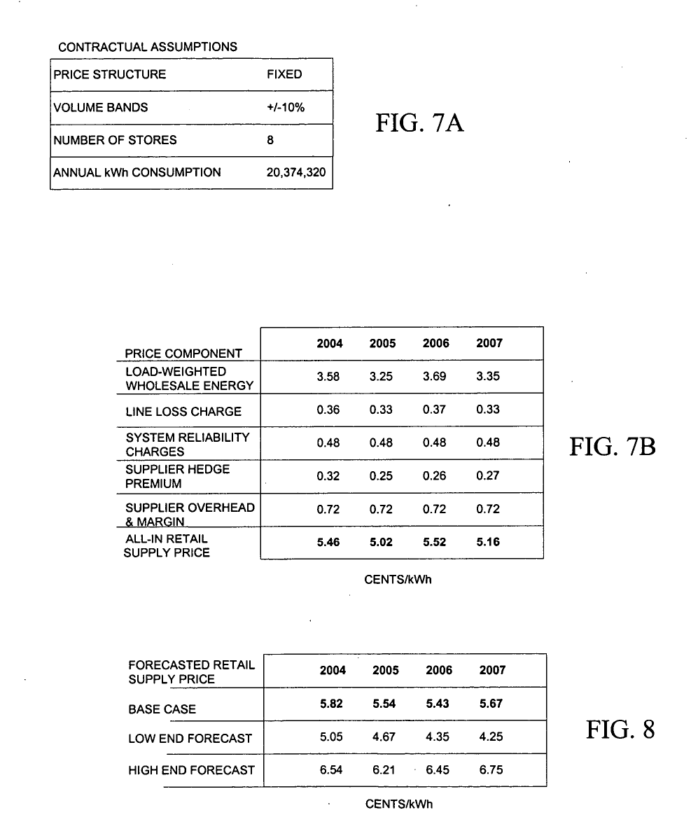

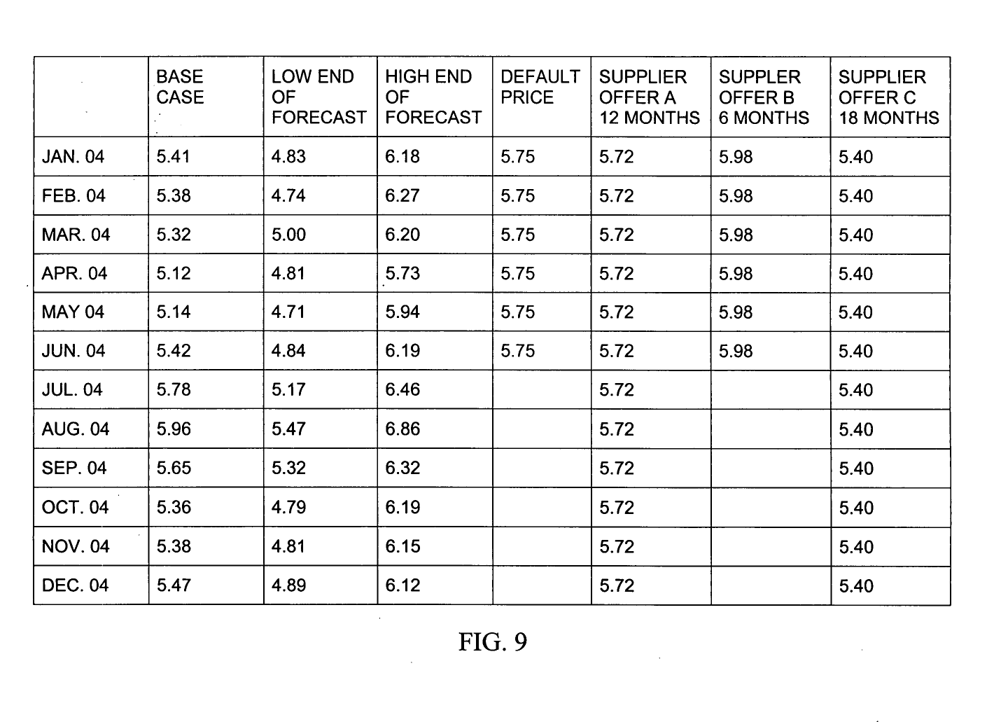

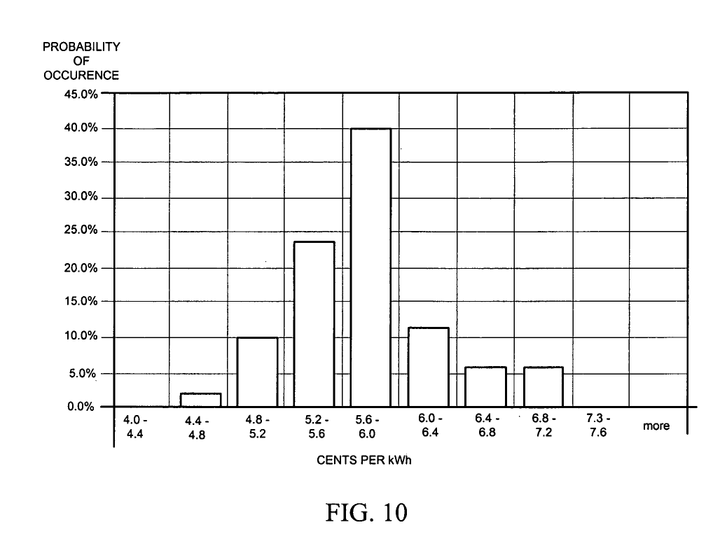

FIGS. 7-10 represent the formats that are used to provide fixed-price forecast information to a customer. The invention calculates an expected case and probabilistic outcomes (e.g., 10^{th} percentile and 90^{th} percentiles) on both a monthly and annual basis. FIGS. 7A-7B represents the format of data given to customers showing contractual assumptions and breakouts of pricing components. FIG. 8 represents supply price on the base case, 10^{th} and 90^{th} percentile forecast for customers. FIG. 9 represents customer specific supply price analysis given in monthly format and matched against the default prices and supplier offers for different contract lengths in the market. FIG. 10 is a histogram showing probabilistic distribution of forecasted retail electric prices for a given customer's facility or portfolio of facilities.

Forecasted Cost of Indexed Contracts (Block 546)

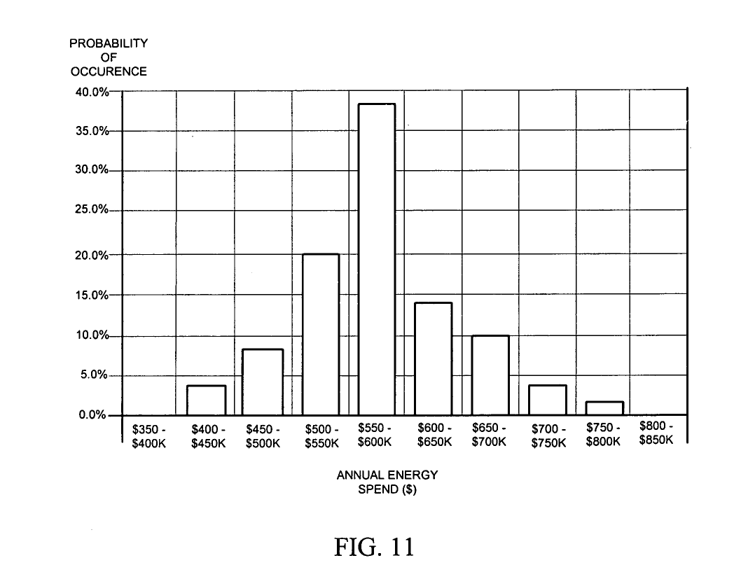

Indexed-based, real-time pricing structures (where a customer pays a market-price for each unit consumed during an interval period) are becoming increasingly common in many retail electric markets and may represent a savings opportunity. But costs under such contracts are less predictable. The costs of such contracts are forecast to help customers devise energy purchasing and risk management strategies. As shown on FIG. 11, the data is presented in a histogram format to show the range of possible energy spending outcomes for the customer. This analysis can also be performed on a monthly basis.

The analysis is performed by the following equation with the results of each iteration tabulated and presented in the graphic in FIG. 11.

For i=1 to i=n

$$Indexed {Cost}_{i} = {\sum }_{j = 1}^{j = k} ( {AP}_{i , j} \times {AL}_{i , j} )$$

Next i

where

Indexed Costᵢ=indexed cost for iteration i($)

AP_{i,j}=simulated price for time interval j and iteration i ($/MWh)

AL_{i,j}=simulated load for time interval j and iteration i (MWh)

i=iteration i=1, 2,3, . . . n

j=time interval j=1, 2,3, . . . k

Cash-Flow at Risk (CFaR) (Block 552)

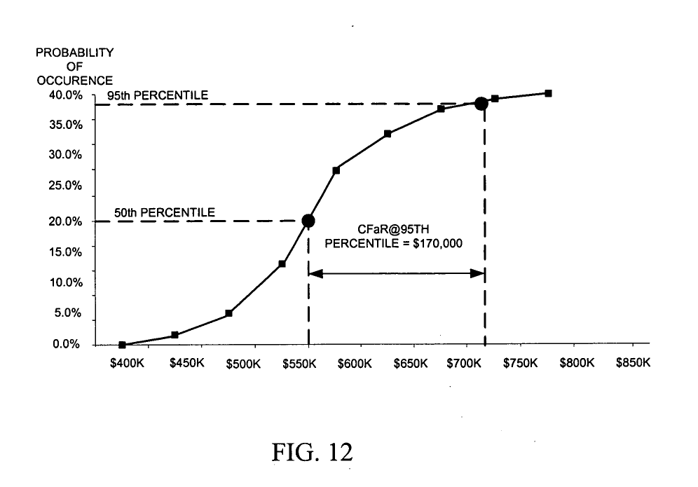

CFAR measures the potential deviation from the expected cost of a contract due to variation in energy prices and volumes. As shown in FIG. 12, CFaR can inform energy managers about the amount of energy spending at risk during a given year. The graph shows that at the 95th percentile, the energy manager could see energy spending of $170,000 greater than the expected value. This is important to understand in valuing different contract structures or deciding, in this case, to enter into a variable, indexed-based contract.

The analysis for CFaR is most often applied to the indexed basis contract valuation. The analysis can also be performed for TOU and fixed-price contracts using the same methodology.

CFaR is calculated as the difference between the expected energy spending and the 95th percentile and is mathematically interpreted as:

For i=1 toi=n

$$Indexed {Cost}_{i} = {\sum }_{j = 1}^{j = k} ( {AP}_{i , j} \times {AL}_{i , j} )$$

Next i

CFaR=(Indexed Costᵢ @ 95th Percentile Iteration)—(Indexed Costᵢ @ 50th Percentile Iteration)

where

Indexed Costᵢ=indexed cost for iteration i ($)

AP_{i,j}=simulated price for time interval j and iteration i ($/MWh)

AL_{i,j}=simulated load for time interval j and iteration i (MWh)

i=iteration i=1, 2,3, . . . n

j=time interval =1, 2,3, . . . k

Price Duration Analysis (Block 554)

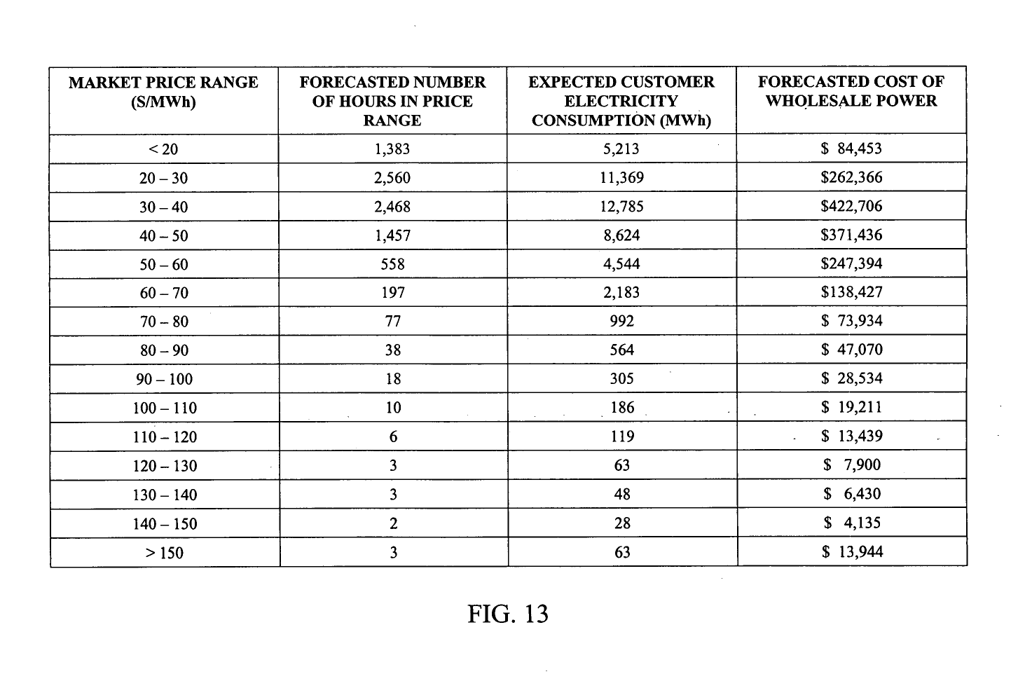

A price duration analysis displays the number of hours that prices are forecasted to be at certain levels matched with the corresponding customer load forecasted for such hours. The ability to capture high price events and the corresponding load is a valuable metric in understanding the economics of alternative pricing structures and the expected value that can be realized by curtailing load or exporting power during periods of high prices. The invention derives this analysis by sorting hourly forecasts of market prices and customer loads into defined price ranges. The analysis can be displayed as an expected case outcome, as shown in FIG. 13, and as probabilistic outcomes (e.g., 10^{th} and 90^{th} percentile). The second column of FIG. 13, “Forecasted Number of Hours in Price Range”, reflects a count of the number of hours that exhibited prices within each specified range. The third column of FIG. 13, “Expected Customer Electricity Consumption”, reflects the sum of the consumption that occurred during the corresponding hours. The fourth column of FIG. 13, “Forecasted Cost of Wholesale Power”, calculates the costs associated with the corresponding price and load events. To value the costs of high priced events to the customer, the invention sums pricing events greater that a specified level to obtain the opportunity costs of installed load management equipment.

Price Risk Options (Block 532)

Suppliers are creating financial protection products that offer the customer both stability and flexibility in deregulated energy markets. Typical options include a) collars (block 534) on indexed-based (variable) contracts that have the effect of reducing the price volatility for a customer, and b) contract extension options (block 536) where the supplier (or customer) has an option to supply (receive) power at an agreed price for a defined period extending beyond the initial contract term. Collar products (block 534) are essentially a series of call options sold and put options bought that have the financial effect of enabling a customer to pay prices within a specific range of prices. Extension options (block 536) represent a put held by the supplier (or call held by the customer). Financial valuation of both types of options is dependent on strike prices, forward prices, and volatility. With the Monte-Carlo simulated results and given the strike price of both caps and floors, the invention values these options for risk assessment.

Collar Analysis Equations (block 534)

For j=1 To j=k

$${VC}_{j} = \frac{{\sum }_{i = 1}^{i = n} [ max ( {AP}_{i , j} - SP ) \times {CL}_{i} ]}{n}$$

$${VF}_{j} = \frac{{\sum }_{i = 1}^{i = n} [ max ( SP - {AP}_{i , j} ) \times {CL}_{j} ] `}{n}$$

Next j

$${CL}_{k} = {\sum }_{j = 1}^{j = k} {CL}_{j}$$

$${VC}_{k} = \frac{{\sum }_{j = 1}^{j = k} {VC}_{j}}{{CL}_{k}}$$

$${VF}_{k} = \frac{{\sum }_{j = 1}^{j = k} {VF}_{j}}{{CL}_{k}}$$

VCLrₖ=value of Floorₖ-Value of Capk

where

VCLₖ=valuation of collar instrument to supplier ($/MWh)

VCₖ=valuation of cap instrument to customer ($/MWh)

VFₖ=valuation of floor instrument to supplier ($/MWh)

SP=supplier defined strike price for option ($/MWh)

APᵢ=simulated energy market clearing price for iteration i ($/MWh)

CLⱼ=contracted quantity for time interval j (MWh)

CLₖ=sum of contract quantity through time interval k (MWh)

j=time interval j=1,2,3, . . . k

i=iteration i=1,2,3, . . . n

For time intervals greater than one year, the collar option is discounted to reflect the time value of money.

Price Risk Options: Extendable Contract Analysis (block 536)

$$\begin{matrix}{VEO}_{i} = {\sum }_{i = l}^{i = n} [ max ( SP - {FP}_{i} , 0 ) \times {AL}_{i , j} ] \\ {VEO}_{k} = \frac{{\sum }_{i = l}^{i = n} {VEO}_{i}}{n}\end{matrix}$$

where

VEOᵢ=valuation of extension offer for iteration i ($)

VEOₖ=valuation of extension instrument to supplier ($)

SP=supplier defined strike price for option ($/MWh)

AL_{i,j}=simulated energy market clearing price for iteration i and time interval j (MWh)

j=time interval j=1,2,3, . . . k

i=iteration i=1,2,3, . . . n

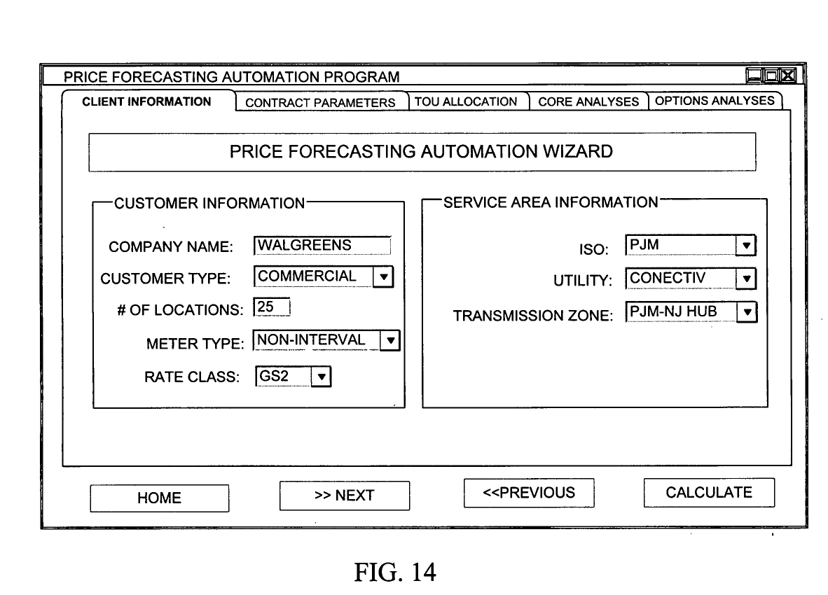

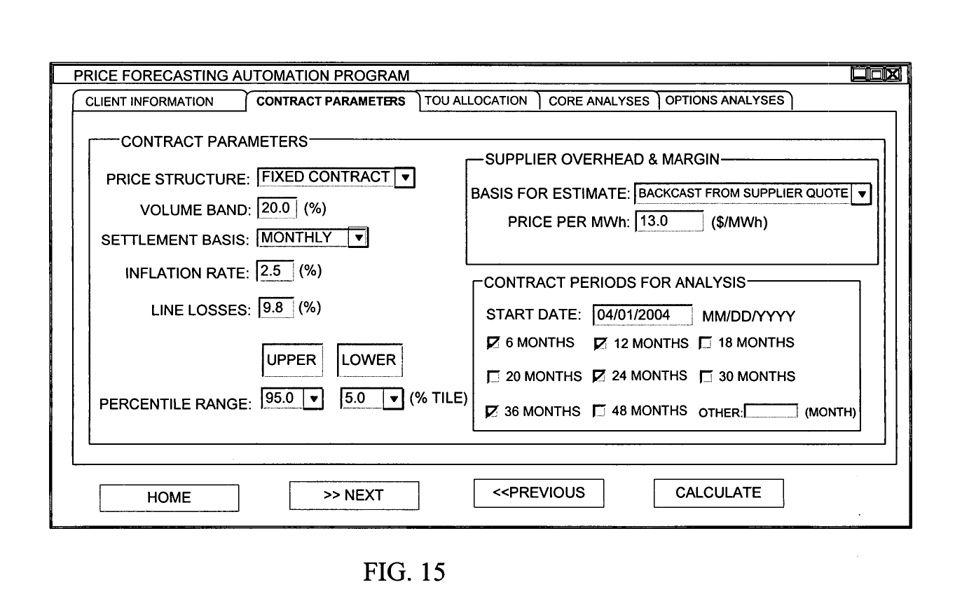

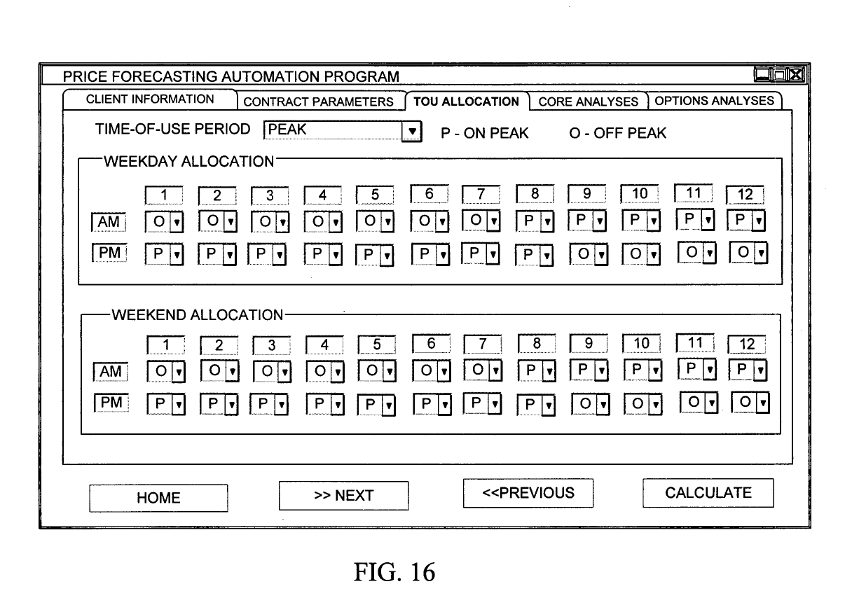

FIGS. 14-18 represent a set of screen displays depicting aspects of the interface for the price forecasting automation program of the present invention. The client information interface illustrated in FIG. 14 enables both customer information and service area information to be entered as inputs to the price forecasting program. Customer information includes company name, customer type, number of locations in the service area, meter type (e.g., non-interval, interval), and rate class. The service area information includes the Independent Service Operator (ISO), the utility company and the transmission zone. The contract parameters interface is illustrated in FIG. 15. The contract parameters include price structure, (e.g., fixed contract), volume band, settlement basis, inflation rate, line losses and percentile range. These parameters have been discussed above. In addition, supplier overhead and margin and contract periods for analysis can also be input into the price forecasting program. Sample data entries are also shown in the figure. An interface for time of use contracts is shown in FIG. 16. Both weekday and weekend allocation are made for each hour as either peak or off peak.

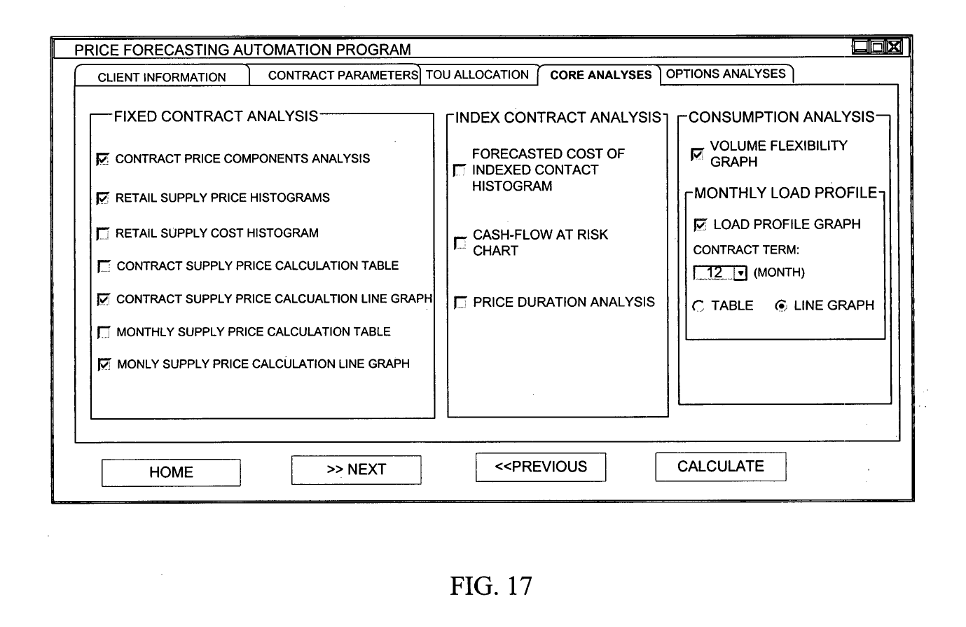

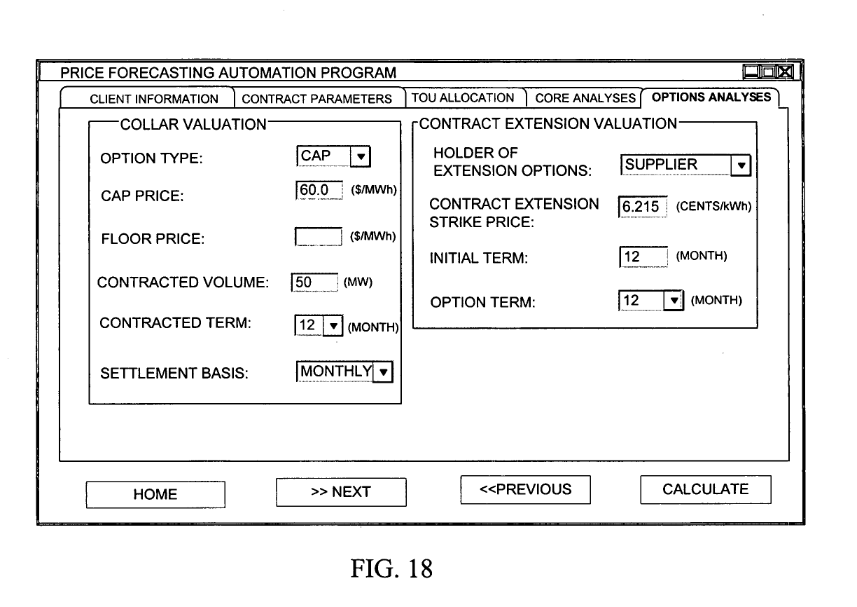

The interface for performing core analyses is illustrated in FIG. 17. The interface in this example is divided into three sections: fixed contract analysis (for fixed price contracts), an index contract analysis for indexed contracts, and a consumption analysis section. In the example shown, for a fixed price contract analysis, contract price components analysis, retail supply price histograms, contract supply price calculation line graph and monthly supply price calculation line graph have been selected. For consumption analysis, volume flexibility graph and load profile graph have been selected. FIG. 18 illustrates sample entries for performing collar valuation and contract extension valuation, respectively. The collar valuation section includes option type (e.g., cap, floor), cap price, floor price, contracted volume, contracted term and settlement basis. The contract extension valuation section includes holder of the contract extension (e.g., supplier), the contract extension strike price, the initial term and the option term.

The present invention can be realized in a combination of software and hardware. Any kind of computer system or other apparatus adapted for carrying out the methods described herein is suited. A typical combination of hardware and software could be a general-purpose computer system that, when loaded and executed with the software, controls the computer system such that it carries out the methods described herein. The present invention can also be embedded in a computer program product, which comprises all the features enabling the implementation of the methods described herein, and which when loaded in a computer system, is able to carry out these methods.

Computer program instructions or computer program in the present context means any expression, in any language, code or notation, of a set of instructions intended to cause a system having an information processing capability to perform a particular function either directly or after either or both of the following occur: (a) conversion to another language, code or notation; (b) reproduction in a different material form.

Those skilled in the art will appreciate that many modifications to the preferred embodiment of the present invention are possible without departing from the spirit and scope of the present invention. In addition, it is possible to use some of the features of the present invention without the corresponding use of other features. Accordingly, the foregoing description of the preferred embodiment is provided for the purpose of illustrating the principles of the present invention and not in limitation thereof, since the scope of the present invention is defined solely by the appended claims.

What is claimed:

1. A method for forecasting a retail price of electricity for an end user customer in a deregulated market, comprising the steps of:
performing a digital simulation of marginal clearing prices and hourly customer load;
determining a risk premium to be added to the forecasted retail price based on an expected wholesale price volatility and an expected variability of customer load;
performing a supply price analysis; and
presenting the results of the supply price analysis to the customer.

2. The method for forecasting retail pricing of electricity of claim 1 further comprising the steps of performing a cash flow at risk analysis and combining the results of the cash flow at risk analysis with the results of the supply price analysis.

3. The method for forecasting retail pricing of electricity of claim 1 further comprising the steps of performing a price duration analysis and combining the results of the price duration analysis with the results of the supply price analysis.

4. The method for forecasting retail pricing of electricity of claim 1 further comprising the steps of performing a cash flow at risk analysis and performing a price duration analysis and combining the results with the results of the supply price analysis.

5. The method for forecasting retail pricing of electricity of claim 1 wherein the step of determining a risk premium comprises:
determining a load-weighted wholesale price for a specified time period;
determining a total risk premium associated with serving the customer load.

6. The method for forecasting retail pricing of electricity of claim 5 wherein the step of determining the total risk premium associated with serving a customer load comprises:
determining a retail risk premium for serving the customer load for each simulation iteration over a specific time period; and
determining the average total risk premium for serving the customer load for a specific number of simulation iterations for the specific time period.

7. The method for forecasting retail pricing of electricity of claim 1 further comprising the step of determining an allocation of the risk premium between a supplier and the customer.

8. The method for forecasting retail pricing of electricity of claim 7 wherein the step of determining the allocation of the risk premium comprises evaluating a supplier pricing structure and demand-based volume swings.

9. The method for forecasting retail pricing of electricity of claim 8 wherein the supplier pricing structure is at least one of a fixed price structure, a time-of-use price structure, an indexed price structure, and a hybrid combination thereof.

10. The method for forecasting retail pricing of electricity of claim 9 wherein the fixed price structure establishes retail supply prices for a specific time period and a specific consumption range.

11. The method for forecasting retail pricing of electricity of claim 9 wherein the time-of-use price structure established retail supply prices into at least two time blocks based on expected consumption demand.

12. The method for forecasting retail pricing of electricity of claim 8 wherein the demand-based volume swings represent a volume band of variation from an expected baseline consumption pattern.

13. The method for forecasting retail pricing of electricity of claim 8 wherein the step of determining the allocation of the risk premium further comprises the steps of:
examining a stochastic load forecast to determine the simulation iterations in which the customer load was outside of allowable volume bands; and
determining the allocation between the supplier and the customer for each simulation iteration in which the customer load was outside the allowable volume bands.

14. The method for forecasting retail pricing of electricity of claim 8 further comprising the step of presenting an analysis to the customer of the cost and risk trade-offs for a plurality of pricing structures and demand-based volume bands.

15. The method for forecasting retail pricing of electricity of claim 2 wherein the step of performing a cash flow at risk analysis comprises measuring a potential deviation from an expected cost of a supply contract based on a variation in energy prices and demand volumes.

16. The method for forecasting retail pricing of electricity of claim 15 wherein the step of performing a cash flow at risk analysis comprises determining a difference between an expected energy spending and the energy spending at a designated percentile.

17. The method for forecasting retail pricing of electricity of claim 3 wherein the step of performing price duration analysis comprises sorting hourly forecasts of market prices and customer loads into a plurality of price bins and displaying the results as an expected case outcome, a low percentile outcome and a high percentile outcome.

18. The method for forecasting retail pricing of electricity of claim 1 wherein the step of performing a supply price analysis comprises an aggregation of a load-weighted wholesale price, a line loss adder, a plurality of system reliability charges, a supplier risk premium, an overhead and a profit margin.

19. The method for forecasting retail pricing of electricity of claim 18 wherein the load-weighted wholesale price is dependent on an expected load profile, a forecast of market prices, and a customer-supplier contract period.

20. The method for forecasting retail pricing of electricity of claim 18 wherein the line loss adder represents an amount of energy lost over a plurality of transmission and distribution lines.

21. The method for forecasting retail pricing of electricity of claim 18 wherein the plurality of system reliability charges include an installed capacity service charge and an ancillary service charge.

22. The method for forecasting retail pricing of electricity of claim 21 wherein the ancillary service charge includes at least one of spinning reserves, non-spinning reserves, regulation-up, regulation-down and black start charges.

23. The method for forecasting retail pricing of electricity of claim 18 wherein the supplier risk premium is determined based on a pricing structure, a contract duration, a price volatility, a load variability and a degree of contract volume variability.

24. The method for forecasting retail pricing of electricity of claim 1 further comprising the step of performing a financial valuation of options embedded in a customer-supplier contract.

25. The method for forecasting retail pricing of electricity of claim 24 wherein the step of performing a financial valuation of options includes the valuation of a collar on an indexed-based price structure.

26. The method for forecasting retail pricing of electricity of claim 24 wherein the step of performing a financial valuation of options includes a valuation of a contract extension option.

27. The method for forecasting retailing pricing of electricity of claim 24 wherein the step of performing a financial valuation of options includes evaluation of strike prices, forward prices, and volatility.

28. A computer program product for forecasting a retail price of electricity for an end-user customer in a deregulated market, comprising:
a computer usable medium having computer readable code embodied therein, the computer usable medium comprising:
program instructions that determine a risk premium to be added to the forecasted retail price based on an expected wholesale price volatility and an expected variability of customer load;
program instructions that perform a supply price analysis; and
program instructions that present the results of the supply price analysis to the customer.

29. The computer program product for forecasting retail pricing of electricity of claim 28 wherein the computer usable medium further comprises program instructions that perform a cash flow at risk analysis and combine the results of the cash flow at risk analysis with results of the supply price analysis.

30. The computer program product for forecasting retail pricing of electricity of claim 28 wherein the computer usable medium further comprises program instructions that perform a price duration analysis and combine the results of the price duration analysis with the results of the supply price analysis.

31. The computer program product for forecasting retail pricing of electricity of claim 28 wherein the computer usable medium further comprises:
program instructions that perform a cash flow at risk analysis;
program instructions that perform a price duration analysis; and
program instructions that combine the results of the cash flow at risk analysis and the price duration analysis with the results of a supply price analysis.

32. The computer program product for forecasting retail pricing of electricity of claim 28 wherein the program instructions that determine a risk premium comprise:
program instructions that determine a load-weighted wholesale price for a specific time period; and
program instructions that determine a total risk premium associated with serving a customer load.

33. The computer program product for forecasting retail pricing of electricity of claim 32 wherein the program instructions that determine a total risk premium associated with serving a customer load comprise:
program instructions that determine a retail risk premium for serving the customer load for each simulation iteration over a specific time period; and
program instructions that determine the average total risk premium for serving the customer load for a specific number of simulation iterations for the specific time period.

34. The computer program product for forecasting retail pricing of electricity of claim 28 wherein the computer usable medium further comprises program instructions that determine an allocation of the risk premium between a supplier and the customer.

35. The computer program product for forecasting retail pricing of electricity of claim 34 wherein the program instructions that determine the allocation of the risk premium comprise program instructions that evaluate a supplier pricing structure and demand-based volume swings.

36. The computer program product for forecasting retail pricing of electricity of claim 35 wherein the supplier pricing structure is at least one of a fixed price structure, a time-of-use price structure, and an indexed price structure.

37. The computer program product for forecasting retail pricing of electricity of claim 36 wherein the demand-based volume swings represent a volume band of variation from an expected base line consumption pattern.

38. The computer program product for forecasting retail pricing of electricity of claim 36 wherein the program instructions that determine the allocation of the risk premium comprise:
program instructions that examine a stochastic load forecast to determine the simulations iterations in which a customer load was outside of allowable volume bands; and
program instructions that determine the allocation between the supplier and the customer for each simulation iteration in which the customer load was outside the allowable volume bands.

39. The computer program product for forecasting retail pricing of electricity of claim 36 wherein the computer usable medium further comprises program instructions that present an analysis to the customer of the cost and risk tradeoffs for a plurality of pricing structures and demand-based volume bands.

40. The computer program product for forecasting retail pricing of electricity of claim 29 wherein the program instructions that perform a cash flow at risk analysis comprise program instructions that measure a potential deviation from an expected cost of a supply contract based on a variation in energy prices and demand volumes.

41. The computer program product for forecasting retail pricing of electricity of claim 40 wherein the program instructions that perform a cash flow at risk analysis comprise program instructions that determine a difference between an expected energy spending and the energy spending at a designated percentile.

42. The computer program product for forecasting retail pricing of electricity of claim 30 wherein the program instructions that perform price duration analysis comprise:
program instructions that sort hourly forecast of hourly market prices and customer loads into a plurality of price bins; and
program instructions that display the results as an expected case outcome, a low percentile outcome, and a high percentile outcome.

43. The computer program product for forecasting retail pricing of electricity of claim 28 wherein program instructions that perform a supply price analysis comprise program instructions that aggregate a load-weighted wholesale price, a line loss adder, a plurality of system reliability charges, a supplier risk premium, an overhead, and a profit margin.

44. The computer program product for forecasting retail pricing of electricity of claim 43 wherein the load-weighted wholesale price is dependant on an expected load profile, a forecast of market prices, and a customer-supplier contract period.

45. The computer program product for forecasting retail pricing of electricity of claim 43 wherein the line loss adder represents an amount of energy loss over a plurality of transmission and distribution lines.

46. The computer program product for forecasting retail pricing of electricity of claim 43 wherein the plurality of system reliability charges include an installed capacity service charge and an ancillary service charge.

47. The computer program product for forecasting retail pricing of electricity of claim 43 wherein the supplier risk premium is determined based on the pricing structure, a contract duration, a price duration volatility, a load variability, and a degree of contract volume variability.

48. The computer program product for forecasting retail pricing of electricity of claim 28 wherein the computer usable medium further comprises program instructions that perform a financial valuation of options embedded in a customer-supplier contract.

49. The computer program product for forecasting retail pricing of electricity of claim 48 wherein the instructions that perform a financial valuation of options include program instructions that evaluate a collar on an index-based price structure.

50. The computer program product for forecasting retail pricing of electricity of claim 48 wherein the program instructions that perform a financial valuation of options include program instructions that evaluate a contract extension option.

51. The computer program product for forecasting retail pricing of electricity of claim 48 wherein the program instructions that perform a financial valuation of options include program instructions that evaluate strike prices, forward prices and volatility.

52. A computer system for forecasting a retail price of electricity for an end-user customer in a deregulated market, comprising:
a component that performs a digital simulation of marginal clearing prices and hourly customer load;
a component that determines a risk premium to be added to the forecasted retail price based on an expected wholesale price volatility and an expected variability of customer load;
a component that performs a supply risk analysis; and
a component that presents the results of the supply price analysis to the customer.

53. The system for forecasting retail pricing of electricity of claim 52 further comprising a component that performs a cash flow at risk analysis and combines the results of the cash flow at risk analysis with the results of the supply price analysis.

54. The system for forecasting a retail price of electricity of claim 52 further comprising a component that performs a price duration analysis and combines the results of the price duration analysis with the results of a supply price analysis.

55. The system for forecasting a retail price of electricity of claim 52 further comprising a component that performs a cash flow at risk analysis and a price duration analysis and combines the results with the results of the price analysis.

56. The system for forecasting a retail price of electricity of claim 52 wherein the component that determines a risk premium comprises:
a module that determines a load-weighted wholesale price for a specified time; and
a module that determines a total risk premium associated with serving a customer load.

57. The system for forecasting a retail price of electricity of claim 52 further comprising a component that determines an allocation of the risk premium between the supplier and the customer.

58. The system for forecasting a retail price of electricity of claim 57 wherein the component that allocates the risk premium comprises a module that evaluates a supplier pricing structure and demand-based volume swings.

59. The system for forecasting retail pricing of electricity of claim 57 wherein the component that determines the allocation of the risk premium further comprises:
a module that examines a stochastic load forecast to determine the simulation iterations in which the customer load was outside of allowable volume bands; and
a module that determines the allocation between the supplier and the customer for each simulation iteration in which the customer load was outside the allowable volume bands.

60. The system for forecasting retail pricing of electricity of claim 57 further comprising a component that presents an analysis to the customer of the cost and risk tradeoffs for a plurality of pricing structures and demand-based volume bands.

61. The system for forecasting a retail price of electricity of claim 53 wherein the component that performs a cash flow at risk analysis comprises a module that measures a potential deviation from an expected cost of a supply contract based on a variation in energy prices and demand volumes.

62. The system for forecasting a retail price of electricity of claim 61 wherein the component that performs a cash flow at risk analysis comprises a module that determines a difference between an expected energy spending and the energy spending at a designated percentile.

63. The system for forecasting a retail price of electricity of claim 54 wherein the component that performs price duration analysis comprises a module that sorts hourly forecast of market prices and customer loads into a plurality of price bins and a module that displays the results as an expected case outcome, a low percentile outcome, and a high percentile outcome.

64. The system for forecasting a retail price of electricity of claim 52 wherein the component that performs a supply price analysis comprises a module that aggregates a load-weighted wholesale price, a line loss adder, a plurality of system reliability charges, a supplier risk premium, an overhead, and a profit margin.

65. The system for forecasting a retail price of electricity of claim 52 further comprising a component that performs a financial valuation of options embedded in a customer-supplier contract.

66. The system for forecasting a retail price of electricity of claim 65 wherein the component that performs a financial valuation of options includes a module that evaluates the effect of a collar on an indexed-based price structure.

67. The system for forecasting a retail price of electricity of claim 65 wherein the component that performs a financial valuation of options includes a module that evaluates the effect of a contract extension option.

68. The system for forecasting a retail price of electricity of claim 65 wherein the component that performs a financial valuation of options includes a module that evaluates the effect of strike prices, forward prices, and volatility.
